(19) United States
(12) Patent Application Publication
(10) Pub. No.: US 2016/0325500 A1
(43) Pub. Date: Nov. 10, 2016

(54) DNA SEQUENCING OF 3D FILES

(71) Applicant: Ocean Print Limited, Dublin 2 (IE)

(72) Inventor: Shane Hassett, Abbeyfeale (IE)

(21) Appl. No.: 14/703,713

(22) Filed: May 4, 2015

(51) Int. Cl. B29C 67/00; G06F 17/30; G05B 19/4099

(52) U.S. Cl. CPC B29C 67/0088; G05B 19/4099; G06F 17/30424; G05B 2219/35134; G05B 2219/49007; B33Y 50/02

(57) ABSTRACT

Systems, methods, apparatuses, and computer program products for preventing unauthorized printing of 3D objects are provided. One method may include converting, by a device, a shape of a three dimensional (3D) object into a sequence comprising a unique combination of digits specific to the 3D object, and comparing the sequence against a database containing a plurality of sequences representing objects or products. When one of the plurality of sequences in the database is found to match the sequence, printing of the 3D object may be prevented or blocked.

### BACKGROUND

1. Field

Embodiments of the invention generally relate to 3D printing or additive manufacturing. In particular, some embodiments relate to methods and systems for identifying and preventing the printing of objects that infringe intellectual property or illegal/dangerous products, for example.

2. Description of the Related Art

3D printing or additive manufacturing may refer to processes used to make a three-dimensional object. 3D printing may utilize additive processes in which successive layers of material are placed down under the control of a computer. The process may be performed by a 3D printer, which is essentially a type of industrial robot. 3D printed objects may be basically of any shape or geometry, and may be produced from a 3D model or other electronic data source.

3D printable models may be created with a computer aided design (CAD) package, a 3D scanner, a plain digital camera and/or photogrammetry software. 3D scanning is a process of analyzing and collecting digital data on the shape and appearance of a real object. Based on this data, three-dimensional models of the scanned object can then be produced.

However, there is a need for a procedure to ensure that 3D printed objects do not infringe the intellectual property of another, and/or to ensure that the object being printed is not illegal.

### SUMMARY

One embodiment is directed to a method that may include converting, by a device, a shape of a three dimensional (3D) object into a sequence comprising a unique combination of digits specific to the 3D object, comparing the sequence against a database containing a plurality of sequences representing objects or products, and, when one of the plurality of sequences in the database is found to match the sequence, preventing printing of the 3D object.

In an embodiment, the converting may further include using an electronic representation of the 3D object stored in a digital file to obtain the shape of the 3D object. According to one embodiment, the converting may include using stereolithography to describe a surface geometry of the 3D object and converting co-ordinates created by the stereolithography into the sequence.

According to certain embodiments, the sequence is found to have matched said one of the plurality of sequences in the database when a predetermined number of the digits in the sequence are found to match digits in said one of the plurality of sequences.

In one embodiment, when one of the plurality of sequences in the database is found to match the sequence, the method may include notifying stakeholders in the 3D object of an attempt to print the 3D object. According to an embodiment, the preventing may include notifying a 3D printer that it is not authorized to print the 3D object. In certain embodiments, the comparing further comprises examining a purchase history of the 3D object to determine whether printing of the 3D object is authorized.

Another embodiment is directed to an apparatus, which may include at least one processor and at least one memory comprising computer program code. The at least one processor, when loaded with the computer program code, is configured to control the apparatus at least to convert a shape of a three dimensional (3D) object into a sequence comprising a unique combination of digits specific to the 3D object, compare the sequence against a database containing a plurality of sequences representing objects or products, and when one of the plurality of sequences in the database is found to match the sequence, prevent printing of the 3D object.

In an embodiment, the converting may include using stereolithography to describe a surface geometry of the 3D object and converting co-ordinates created by the stereolithography into the sequence. According to certain embodiments, the sequence is found to have matched said one of the plurality of sequences in the database when a predetermined number of the digits in the sequence are found to match digits in said one of the plurality of sequences.

In some embodiments, when one of the plurality of sequences in the database is found to match the sequence, the at least one processor is configured to control the apparatus to notify stakeholders in the 3D object of an attempt to print the 3D object. According to an embodiment, the at least one processor is configured to control the apparatus to prevent printing of the 3D object by notifying a 3D printer that it is not authorized to print the 3D object. In certain embodiments, the at least one processor is configured to control the apparatus to examine a purchase history of the 3D object to determine if printing of the 3D object is authorized.

Another embodiment is directed to a computer program, embodied on a computer readable medium, wherein the computer program is configured to control a processor to perform a process. The process may include converting a shape of a three dimensional (3D) object into a sequence comprising a unique combination of digits specific to the 3D object, comparing the sequence against a database containing a plurality of sequences representing objects or products, and, when one of the plurality of sequences in the database is found to match the sequence, preventing printing of the 3D object.

In an embodiment, the converting may further include using an electronic representation of the 3D object stored in a digital file to obtain the shape of the 3D object. According to one embodiment, the converting may include using stereolithography to describe a surface geometry of the 3D object and converting co-ordinates created by the stereolithography into the sequence.

According to certain embodiments, the sequence is found to have matched said one of the plurality of sequences in the database when a predetermined number of the digits in the sequence are found to match digits in said one of the plurality of sequences.

In one embodiment, when one of the plurality of sequences in the database is found to match the sequence, the process may include notifying stakeholders in the 3D object of an attempt to print the 3D object. According to an embodiment, the preventing may include notifying a 3D printer that it is not authorized to print the 3D object. In certain embodiments, the comparing further comprises examining a purchase history of the 3D object to determine whether there is authorization to print the object.

### BRIEF DESCRIPTION OF THE DRAWINGS

For proper understanding of the invention, reference should be made to the accompanying drawings, wherein:

FIG. 1 illustrate a system according to one embodiment;

FIG. 2 illustrates an apparatus according to an embodiment; and

FIG. 3 illustrates a flow diagram of a method according to an embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for preventing unauthorized 3D printing, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

In one embodiment, a sequence (e.g., DNA sequence) is created from the shape of a 3D object and translated into a unique combination of digits. The DNA sequence is used to check whether the printer is authorized to print the 3D object. If it is not authorized, then the system prevents the 3D printer from printing the object. As such, embodiments utilize DNA sequencing to prevent the printing of objects that infringe intellectual property or of dangerous or illegal products, such as guns.

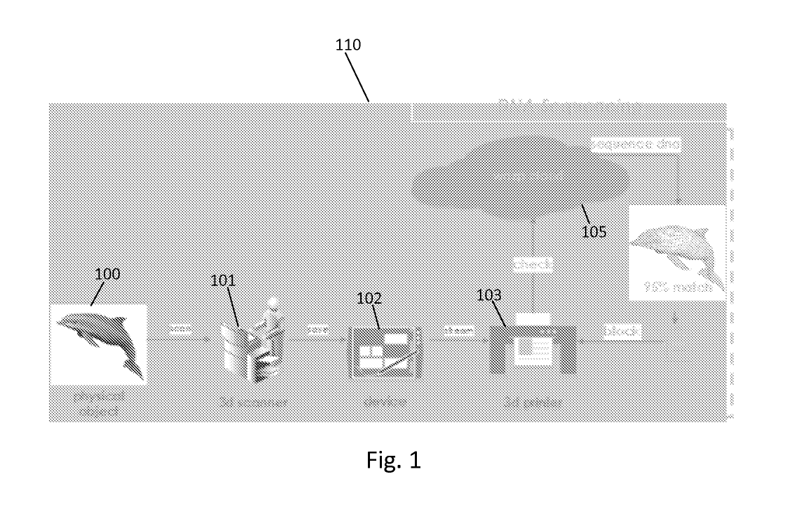

FIG. 1 illustrates an example system 110 according to one embodiment of the invention. As illustrated in FIG. 1, in an embodiment, a real world object 100 may be scanned by a 3D scanner 101. In order for the product to be printed, a digital representation of the surface of the product is created by the 3D scanner 101 and saved in device 102. According to this embodiment, the digital representation of the object 100 may be converted, for example by device 102, into a series of numbers (e.g., DNA Code) that represents the product shape, size, and appearance. The physical attributes that are assigned to the product (e.g., texture, color, finish) may also be noted.

Then, prior to 3D printer 103 printing the object, a check is performed to make sure that the object is approved for printing. In particular, 3d printer 103 may seek authorization from a server 105, which may be contained among cloud resources. For example, in an embodiment, the DNA code (and optionally the physical attributes) is forwarded or sent to server 105, which may include a database storing descriptions (e.g., sequences) that represent various objects/products. The DNA code (and possibly the physical attributes) is compared with each of the sequences stored in the database.

If a match is found between the DNA code (and possibly the physical attributes) of the object 100 and any of the objects in the database, then the product purchase history may also be examined, comparing the purchaser information and printer information against the information of the printer 103 and individual attempting to print the product. If it is found that the authority to print the object 100 has not been assigned to the 3D printer 103 or the individual, or that the printer 103 and individual has already completed the print of the object 100, then the system 110 does not authorize the printing of the object 100. In other embodiments, just finding a match between the DNA code (and possibly the physical attributes) and any of the objects in the database, will be enough to prevent printing of the object 100.

In an example embodiment, a match is determined to have been found if there is a match within a predetermined range or level, such as for example a 95% match. Such a match may be used by system 110 to conclude that a desire to make a duplicate without payment to the product owner exists.

System 110 may further inform the individual attempting to print the object of the issue. In addition, according to one embodiment, system 110 may be further configured to inform the owner or stakeholder of the object (e.g., the owner of the intellectual property in the object), or a retailer, of the attempted printing of the object.

Thus, according to the system 110 of FIG. 1, the 3D printer 103 that is being used to print the product 100 seeks authentication from a server to confirm that the product print request is genuine and has been legally obtained. A source file without an existing DNA Code interacts with the server to have its surface converted into a DNA Code by embodiments of the invention, as discussed above. The created DNA Code and assigned physical attributes are compared against the database of product DNA Codes within the system structure. When the system 110 discovers an existing DNA Code match but no print authority has been obtained by the individual or printer, the system 110 signals that this is an illegally obtained source file and no authentication is provided to the printer. The system 110 may then inform the appropriate stakeholders.

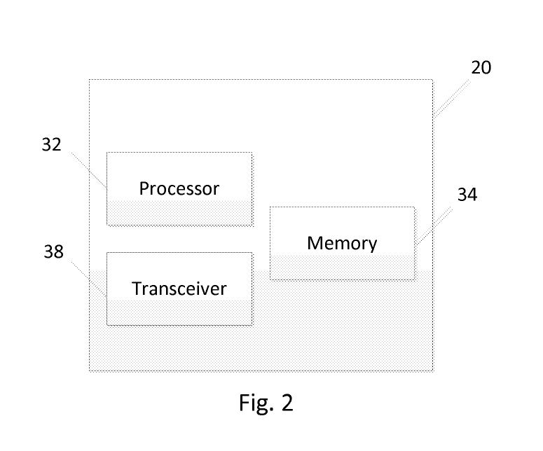

FIG. 2 illustrates an example of an apparatus 20 according to an embodiment. In an embodiment, apparatus 20 may be a node, host, or server in a network. In an embodiment, apparatus 20 may be a 3D printer or a device controlling such a 3D printer. It should be noted that one of ordinary skill in the art would understand that apparatus 20 may include components or features not shown in FIG. 2.

As illustrated in FIG. 2, apparatus 20 may include a processor 32 for processing information and executing instructions or operations. Processor 32 may be any type of general or specific purpose processor. While a single processor 32 is shown in FIG. 2, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further comprise or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas (not shown) for transmitting and receiving signals and/or data to and from apparatus 20. Apparatus 20 may further include or be coupled to a transceiver 38 configured to transmit and receive information, signals and/or data. For instance, transceiver 38 may be configured to modulate information on to a carrier waveform for transmission by the antenna(s) and demodulate information received via the antenna(s) for further processing by other elements of apparatus 20. In other embodiments, transceiver 38 may be capable of transmitting and receiving signals or data directly.

Processor 32 may perform functions associated with the operation and control of apparatus 20 including. In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a 3D printer or a device for controlling 3D printer. In an embodiment, apparatus 20 may be controlled by memory 34 and processor 32 to translate a shape of a model or electronic representation of a 3D object into a sequence that may comprise a unique combination of digits specific to the 3D object (e.g., DNA code). For example, the DNA code may represent the product shape, size and appearance. In addition, the DNA code may also take into account the physical attributes that are assigned to the product (texture, color, finish).

In an embodiment, the apparatus 20 may be controlled to translate the shape of the object into the DNA code by using stereolithography to describe the surface geometry of the 3D object and converting co-ordinates created by the stereolithography into the DNA code. According to one embodiment, the DNA code may comprise sets of 3 figures, such as for example (7,43,11),(8,44,12), etc. This unique DNA code may then be linked or associated with the object.

According to one embodiment, apparatus 20 may be controlled by memory 34 and processor 32 to compare the DNA code against a database containing a plurality of sequences representing objects or products. In an embodiment, an algorithm may be used that recognizes similarities in sequences of numbers to find numerical matches which identify identical products. When one of the plurality of sequences in the database is found to match the DNA code, apparatus 20 may be controlled by memory 34 and processor 32 to prevent printing of the 3D object.

In certain embodiments, apparatus 20 may also be controlled to cause the product purchase history to also be examined by, for example, comparing the purchaser information and printer information against the information of the apparatus 20 (e.g., 3D printer) and the individual attempting to print the product. If it is found that the authority to print the object has not been assigned to the 3D printer or the individual, or that the printer and individual has already completed the print of the object, then apparatus 20 may be controlled by memory 34 and processor 32 to prevent printing of the 3D object.

In an example embodiment, a match is determined to have been found between the DNA code and the sequences in the database if there is a match within a predetermined range or level, such as for example a 95% or greater match.

According to an embodiment, apparatus 20 may be controlled by memory 34 and processor 32 to automatically search illegal file sharing platforms to identify illegally sourced products. If such illegally sourced products are found to match the 3D object then apparatus 20 may be controlled by memory 34 and processor 32 to prevent printing of the 3D object.

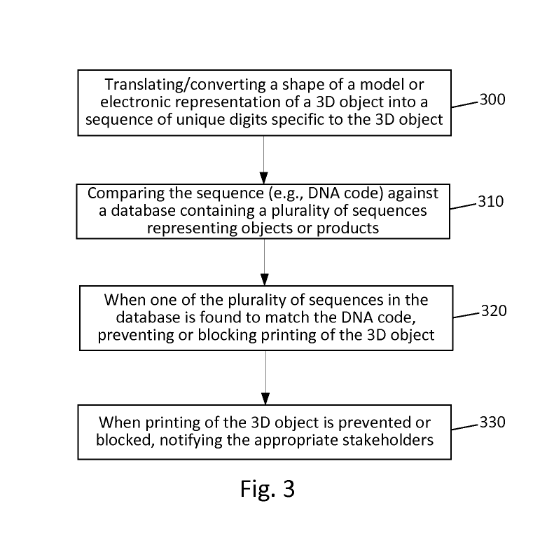

FIG. 3 illustrates an example flow diagram of a method according to one embodiment of the invention. In certain embodiments, the method of FIG. 3 may be performed by a 3D printer or may be performed by a device or controller in communication with a 3D printer. As illustrated in FIG. 3, the method may include, at 300, translating or converting a shape of a model or electronic representation of a 3D object into a sequence that may comprise a unique combination of digits specific to the 3D object. This unique sequence may be referred to as the DNA code for the 3D object. For example, the DNA code may represent the product shape, size, and/or appearance. In addition, the DNA code may also take into account the physical attributes that are assigned to the product (texture, color, finish).

In an embodiment, the translating of the shape of the object into the DNA code may include using stereolithography to describe the surface geometry of the 3D object and converting co-ordinates created by the stereolithography into the DNA code. According to one embodiment, the DNA code may comprise sets of 3 figures, such as for example (7,43,11),(8,44,12), etc. This unique DNA code may then be linked or associated with the object.

According to one embodiment, the method may also include, at 310, comparing the sequence (e.g., DNA code) against a database containing a plurality of sequences representing objects or products. In an embodiment, the comparing may include using an algorithm that recognizes similarities in sequences of numbers to find numerical matches which identify identical products. When one of the plurality of sequences in the database is found to match the DNA code, the method may then include, at 320, preventing or blocking printing of the 3D object. In an example embodiment, a match is determined to have been found between the DNA code and the sequences in the database if there is a match within a predetermined range or level, such as for example a 95% or greater match.

In certain embodiments, the comparing may also include examining the product purchase history by, for example, comparing the purchaser information and printer information against the information of the device (e.g., 3D printer) and the individual attempting to print the product. If it is found that the authority to print the object has not been assigned to the 3D printer or the individual, or that the printer and individual has already completed the print of the object, then printing of the 3D object is prevented or blocked.

According to an embodiment, the method may also include automatically searching illegal file sharing platforms to identify illegally sourced products. If such illegally sourced products are found to match the 3D object, then printing of the 3D object may be prevented or blocked.

When printing of the 3D object is prevented or blocked, the method may also include, at 330, notifying the appropriate stakeholders, such as the owner of intellectual property in the object or appropriate retailers, as well as the individual attempting to print the object.

In some embodiments, the functionality of any method described herein, such as that of FIG. 3, may be implemented by software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software. The computer readable media mentioned above may be, for example, at least partially embodied by a transmission line, a compact disk, digital-video disk, a magnetic disk, holographic disk or tape, flash memory, magnetoresistive memory, integrated circuits, or any other digital processing apparatus memory device.

In view of the above, embodiments of the invention may provide various advantages and/or technical improvements. For example, embodiments are able to prevent the illegal or unauthorized 3D printing of products in order to protect the intellectual property of product owners, reduce risk associated with IP theft through illegal file sharing or reverse engineering through scanning. In addition, embodiments can prevent the illegal printing of dangerous objects, such as guns or other weapons. Such illegal or unauthorized printing may have been, for example, facilitated by 3D scanning, illegal file sharing, or theft of original source files. As a result of embodiments of the invention, only legally obtained and purchased products can be printed, ensuring that the product owner and retailer receive payment for their product and service; while illegally obtained source files cannot be printed.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
converting, by a device, a shape of a three dimensional (3D) object into a sequence comprising a unique combination of digits specific to the 3D object;
comparing the sequence against a database containing a plurality of sequences representing objects or products; and
when one of the plurality of sequences in the database is found to match the sequence, preventing printing of the 3D object.

2. The method according to claim 1, wherein the converting further comprises using an electronic representation of the 3D object stored in a digital file to obtain the shape of the 3D object.

3. The method according to claims 1, wherein the converting comprises using stereolithography to describe a surface geometry of the 3D object and converting co-ordinates created by the stereolithography into the sequence.

4. The method according to claim 1, wherein the sequence is found to have matched said one of the plurality of sequences in the database when a predetermined number of the digits in the sequence are found to match digits in said one of the plurality of sequences.

5. The method according to claim 1, further comprising, when one of the plurality of sequences in the database is found to match the sequence, notifying stakeholders in the 3D object of an attempt to print the 3D object.

6. The method according to claim 1, wherein the preventing comprises notifying a 3D printer that it is not authorized to print the 3D object.

7. The method according to claim 1, wherein the comparing further comprises examining a purchase history of the 3D object.

8. An apparatus, comprising:
at least one processor; and
at least one memory comprising computer program code, wherein the at least one processor, when loaded with the computer program code, is configured to control the apparatus at least to convert a shape of a three dimensional (3D) object into a sequence comprising a unique combination of digits specific to the 3D object;
compare the sequence against a database containing a plurality of sequences representing objects or products; and
when one of the plurality of sequences in the database is found to match the sequence, prevent printing of the 3D object.

9. The apparatus according to claim 8, wherein the converting comprises using stereolithography to describe a surface geometry of the 3D object and converting co-ordinates created by the stereolithography into the sequence.

10. The apparatus according to claim 8, wherein the sequence is found to have matched said one of the plurality of sequences in the database when a predetermined number of the digits in the sequence are found to match digits in said one of the plurality of sequences.

11. The apparatus according to claim 8, further comprising, when one of the plurality of sequences in the database is found to match the sequence, the at least one processor is configured to control the apparatus to notify stakeholders in the 3D object of an attempt to print the 3D object.

12. The apparatus according to claim 8, wherein the at least one processor is configured to control the apparatus to prevent printing of the 3D object by notifying a 3D printer that it is not authorized to print the 3D object.

13. The apparatus according to claim 8, wherein the at least one processor is configured to control the apparatus to examine a purchase history of the 3D object to determine if printing of the 3D object is authorized.

14. A computer program, embodied on a computer readable medium, wherein the computer program is configured to control a processor to perform a process, comprising:
converting a shape of a three dimensional (3D) object into a sequence comprising a unique combination of digits specific to the 3D object;
comparing the sequence against a database containing a plurality of sequences representing objects or products; and
when one of the plurality of sequences in the database is found to match the sequence, preventing printing of the 3D object.

15. The computer program according to claim 14, wherein the converting comprises using stereolithography to describe a surface geometry of the 3D object and converting co-ordinates created by the stereolithography into the sequence.

16. The computer program according to claim 14, wherein the sequence is found to have matched said one of the plurality of sequences in the database when a predetermined number of the digits in the sequence are found to match digits in said one of the plurality of sequences.

17. The computer program according to claim 14, further comprising, when one of the plurality of sequences in the database is found to match the sequence, notifying stakeholders in the 3D object of an attempt to print the 3D object.

18. The computer program according to claim 14, wherein the preventing comprises notifying a 3D printer that it is not authorized to print the 3D object.

19. The computer program according to claim 14, wherein the comparing further comprises examining a purchase history of the 3D object.
